(19) United States
(12) Patent Application Publication
(10) Pub. No.: US 2007/0189294 A1
(43) Pub. Date: Aug. 16, 2007

(54) Methods and Apparatus for Signaling Between Independent Control Networks

(76) Inventors: Jonathan B. Sadler, Naperville, IL (US); T. Benjamin Mack-Crane, Downers Grove, IL (US)

Correspondence Address: WELSH & KATZ, LTD, 120 S RIVERSIDE PLAZA, 22ND FLOOR, CHICAGO, IL, 60606, US

(21) Appl. No.: 11/626,956

(22) Filed: Jan. 25, 2007

Related U.S. Application Data
(60) Provisional application No. 60/762,783, filed on Jan. 28, 2006.

(51) Int. Cl. H04L 12/66; H04L 12/56

(52) U.S. Cl. 370/392; 370/401

(57) ABSTRACT

An apparatus which enables first and second signaling networks to communicate with one another via one or more proxies. Each respective proxy can edit a received message and translate an included address to an address associated with a receiving signaling network.

### CROSS-REFERENCE TO RELATED APPLICATION

This application claims the benefit of the filing date of U.S. Provisional Application Ser. No. 60/762,783 filed Jan. 28, 2006 and entitled “Methods and Apparatus for Signaling Between Independent Communication Networks” and, that application is incorporated herein by reference.

### FIELD

The invention pertains to communications networks. More particularly, the invention pertains to devices and methods that involve separate networks that can quickly and easily communicate control or signaling messages to one another while maintaining a sufficient level of privacy and security.

### BACKGROUND

Network operators often desire to use automated control protocols to establish and release connections across domains with independent communications networks. These control protocols typically utilize a separate communications network having links and message switches to carry control messages. This network is known as the Signaling Communications Network. The resources being controlled are known as the Transport Plane Network. Carriers may desire to maintain the independence, privacy and security of their signaling communications networks. In this situation, networks are adjacent, for example connected by a link in the user plane, but the signaling controllers responsible for the ends of the link are not attached to the same signaling communications network. For example, the signaling controllers responsible for the ends of the link are in separate IP networks with independent, possibly overlapping, addressing plans.

In certain existing signaling protocols, the two communicating peers are assumed to be in the same signaling network. For example, a prior art network 100, see FIG. 1, includes an IP signaling communications network (SCN) 102. Two control software components 104a and 104b are coupled to the SCN 102.

The two control software components 104a,b communicate with each other through a common signaling network, with a common addressing space. If control software component 104a wants to communicate to control software component 104b, the control software component 104a may access the IP address where the control software component 104b is coupled to the signaling communications network 102. Control software component 104a uses this information to easily communicate to control software component 104b. Control software component 104a includes in these messages its signaling communications network address, for example an IP address. As a result, control software component 104b knows where to send response messages.

In other known signaling protocols, a message is sent from a peer located in one signaling communications network to a peer located in another signaling communications network, over a direct link. This scenario requires additional effort and expense because a direct link must be built between control software components within each signaling communications network. Furthermore, the direct link may provide a way to breach security within the two networks where the control software components reside. These links significantly increase the number of points that both service providers need to secure. Service providers generally do not desire this network scenario.

There thus continues to be a need for systems and methods which would enable signaling control elements, or signaling communication networks, associated with separate independent communications networks to readily and efficiently communicate with one another. Preferably such functionality could be achieved without the use of dedicated inter-system signaling channels or links thereby supporting an operator's ability to:
1. manage the operator's communication network address space, by separating subnetworks from a common backbone and independently addressing these subnetworks, thereby giving each subnetwork only one backbone address, and/or
2. maintain independence of their communication network from other operators' communication networks with which they have peering relationships, to improve security and ease operation.

### SUMMARY

First and second separate communications networks coupled together by at least one traffic carrying link include at least one control element coupled to one of the networks. The control element receives at least one message from the one network to be transmitted to the other network. The control element includes address information for the other network, and circuitry for translating a first address representation to an address associated with the other network.

### BRIEF DESCRIPTION OF DRAWINGS

The features and advantages of the present invention are illustrated by way of example and are by no means intended to limit the scope of the present invention to the particular embodiments shown.

FIG. 1 illustrates a known communications network configuration.

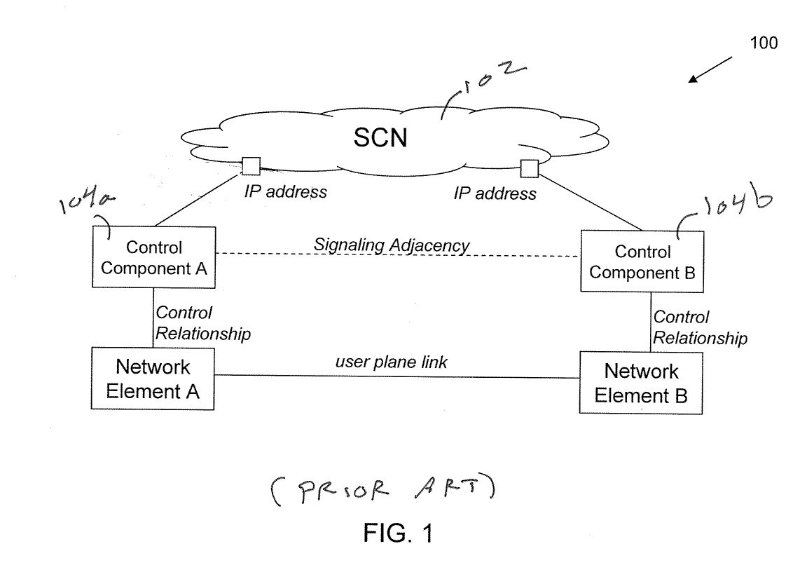

FIG. 2 illustrates a first system implementing an exemplary embodiment of the present invention.

FIG. 3 illustrates a second system implementing an exemplary embodiment of the present invention.

FIG. 4 is a flow diagram illustrating a method for signaling between independent communication networks according to an exemplary embodiment of the present invention.

### DETAILED DESCRIPTION

In the following description, for purposes of explanation, specific nomenclature is set forth to provide a thorough understanding of embodiments of the present invention. It will be apparent to one skilled in the art that specific details in the description may not be required to practice the embodiments of the present invention. In other instances, well-known circuits, devices, and programs are shown in block diagram form to avoid obscuring embodiments of the present invention unnecessarily.

In an embodiment of the invention, a processor and executable software implement at least one gateway to perform address resolution (translation) within a carrier's network. The gateway resolves the problem of a first control component communicating to a second control component where the second control component is separate from and not in the first control component's signaling communication network.

In accordance with the invention, the gateway may act as a proxy that receives a signaling message from a sending control component, evaluates the content of the signaling message, and determines the address in the receiving signaling communication network where the message should be delivered. The gateway may also edit the message to change any signaling communication network addresses contained in the message to correspond to appropriate addresses in the receiving signaling communication network.

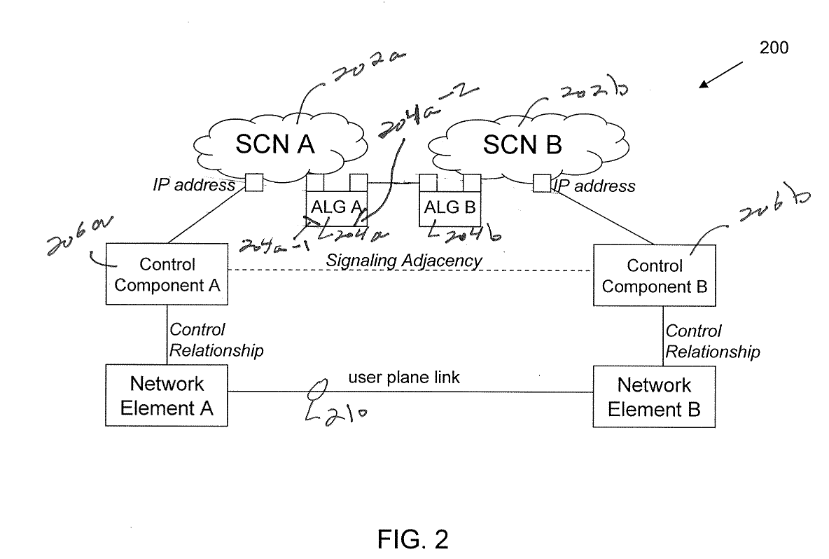

FIG. 2 illustrates an exemplary embodiment of the invention incorporated in a system 200. System 200 includes two adjacent signaling communication networks 202a and 202b. It is a particular advantage of embodiments of the invention that separate, possibly overlapping, signaling communication network address spaces can be present in networks 202a,b. In this embodiment, an application layer gateway 204a is incorporated into signaling communication network 202a. A different application layer gateway 204b is incorporated into signaling communication network 202b. One service provider uses signaling communication network 202a and gateway 204a, while another service provider uses signaling communication network 202b and gateway 204b.

Unlike existing methods where the unique address of a receiving control software component is required for communication purposes to be known by a sending control software component, in the exemplary embodiment of FIG. 2, control software component 206a does not have, and does not need to know the unique address of control software component 206b. In place of the address for control software component 206b, component 206a has the address for gateway 204a.

Gateway 204a in accordance with the invention provides a mechanism which enables control software component 206a to communicate with and send messages to control software component 206b also without needing the address of control software component 206b. Control software component 206a can send a message intended to be sent to control software component 206b by using the supplied address for gateway 204a. Gateway 204a translates and forwards the message to the gateway 204b which forwards it to control software component 206b. As illustrated in FIG. 2, the initial receiver of the message sent by gateway 204a is gateway, 204b.

Gateway 204b then performs similar functions as gateway 204a to forward the message in the direction of control software component 206b. Further, gateway 204b can similarly process a message from control software component 206b intended for control software component 206a.

According to an embodiment of the present invention, gateways 204a,b perform address resolution of the signaling communication network addresses of sending and receiving control software components 206a,b. Gateways 204a,b may perform this by interpreting the messages sent from a sending control software component, such as 206a or 206b, regarding a particular user plane link 210 and determining the address of the receiving control software component 206b or 206a that is responsible for controlling the transport or user plane link and thus to which the message should be forwarded.

Gateways 204a,b may also interpret the messages by using predetermined, or prestored information, such as a table mapping transport, or user plane links, such as 210, to control software components 206a,b. A table of information required to associate a transport plane link to a receiving control software component could be made available to the respective gateway by the service provider operating the respective gateway.

Those of skill in the art will understand that gateways, such as 204a,b can be implemented by one or more processors such as 204a-1 executing gateway related software 204a-2. None of the details of such implementations are limitations of the present invention.

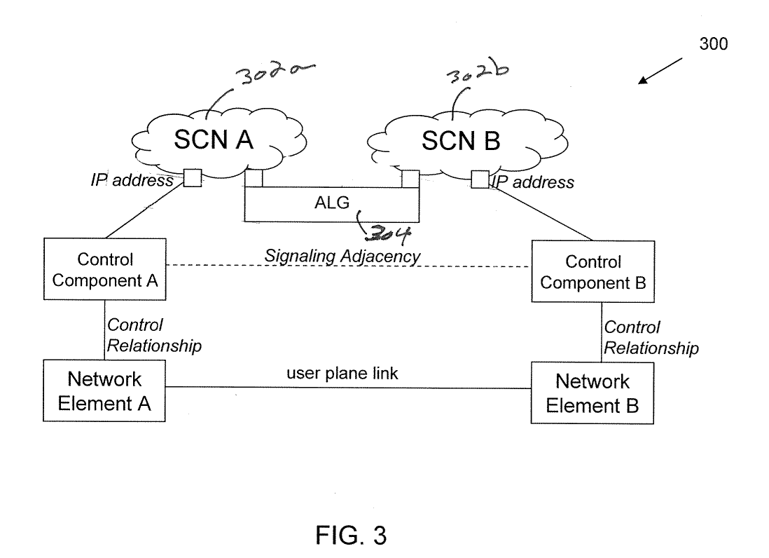

It will also be understood that neither the way in which destination addresses are stored, or generated, by the respective software, such as 204a-2 nor the way in which messages are modified or edited are limitations of the invention. Further, details as to how the gateways communicate with one another are not limitations of the present invention. Communications can be implemented continuously or intermittently via electro-magnetic, or optical media, wired or wirelessly and via one or more networks (Internet for example) or direct links all without limitation. Alternately, as illustrated in FIG. 3, one service provider can use a network 300 containing communication networks 302a,b as in FIG. 2. where one gateway may be used instead of two.

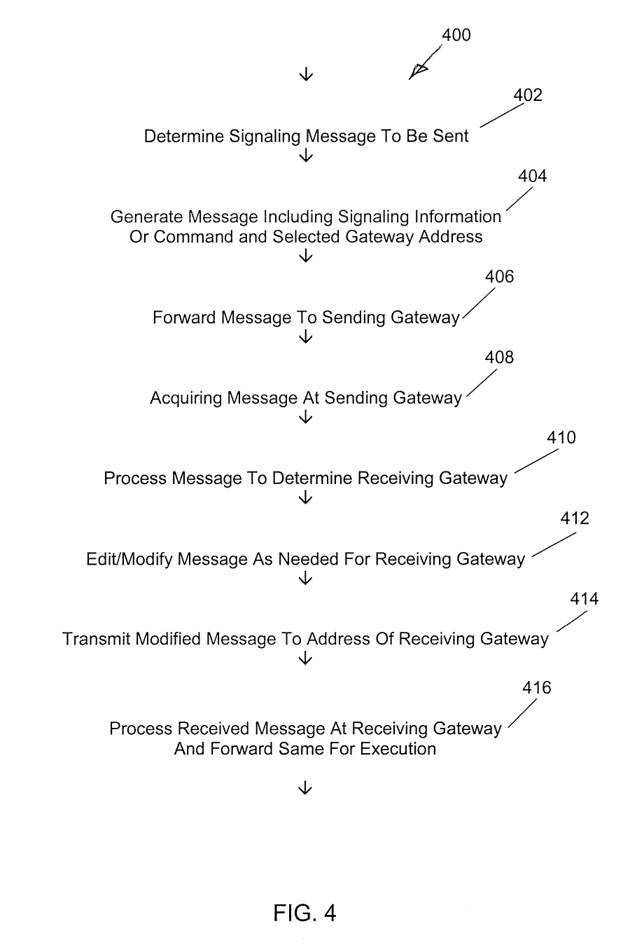

The methods described herein can be used with any signaling protocol that includes a signaling communication address in one of its messages. Upon receiving the message, the respective gateway performs address resolution, for example as described above. FIG. 4 is a flow diagram illustrating a method 400 for performing signaling between independent communication networks according to an embodiment of the present invention.

A determination is made initially that a signaling message is to be sent 402. The message is generated including signaling information or commands and sent to a selected gateway address, 404. The message is forwarded to a sending gateway, 406. The sending gateway acquires the message, 408. The sending gateway processes selected message information to determine the address of the receiving gateway, 410. The message is edited and or modified as needed for the receiving gateway, 412.

The modified message and address is transmitted to the address of the receiving gateway 414. The received message is processed at the receiving gateway and forwarded for execution, 416.

The above processing can be used with a wide variety of message formats. None of the details of such formats are limitations of the invention.

For example, in the case of RSVP (Resource Reservation Protocol), an upstream control component can send a message to the next hop by sending a message to a respective gateway such as 204a. Included in the message is the upstream control component's own IP address and identifier information for the user plane link included in the RSVP HOP object. The message is received by the gateway 204a. The gateway then replaces in the RSVP HOP object the upstream control component's IP address with the gateway's own IP address. Also, the gateway deduces which control component or gateway in the next network should receive the message, based for example, on the upstream control component and user plane link identifier information included in the message. Accordingly, the gateway forwards the message towards the appropriate downstream control component. In this example, gateway 204a forwards the message to gateway 204b. Gateway 204b then performs similar processing to that of gateway 204a and forwards the message to the downstream control component.

Similarly, a message from the downstream control software component can be received by a respective gateway. The message will include the same transport plane link identifier information and based on this information, that gateway can deduce that the message should be forwarded to the appropriate upstream control component.

Systems and methods in accordance herewith can process a variety of message formats and can perform address resolution of a type described above. Exemplary messages are included in, RFC2205, Resource Reservation Protocol (RSVP) Version 1 Functional Specification sections 3.1.3 through 3.1.9, message formats; RFC3209, RSVP-TE: Extensions to RSVP for LSP Tunnels, sections 3.1, 3.2, 4, and 5.1 message and object formats; RFC3473, Generalized Multi-Protocol Label Switching (GMPLS) Signaling Resource Reservation Protocol-Traffic Engineering (RSVP-TE) Extensions, sections 4.3.1 and 10.1 for message formats; and RFC3477, Signaling Unnumbered Links in Resource Reservation Protocol-Traffic Engineering (RSVP-TE), which discusses unnumbered links and a Router ID.

The methods described herein can use unnumbered links and a Node ID, also known as a Router ID. Although the Node ID is not an IP address, in some implementations the Node ID is used as an IP address and gateways in accordance herewith can perform address resolution using the Node ID.

In addition, since not all messages contain a RSVP HOP object, Session and TSpec objects could be used to identify messages as belonging to a particular signaling session and be used as the key to find the appropriate address translation for the message (after the first Path message which initializes communication between two control software components). In a first Path message the RSVP HOP object contains information that would be used to identify the proper address translation and record the Session and TSpec object values for use in handling of later messages in that session.

FIG. 4 is a flow chart illustrating a method for performing signaling between independent communication networks according to an embodiment of the present invention. The techniques illustrated in FIG. 4 may be performed sequentially, in parallel, or in an order other than which is described. The techniques may also be performed one or more times. It should be appreciated that not all of the techniques described are required to be performed, that additional techniques may be added, and that some of the illustrated techniques may be substituted with other techniques.

Software embodiments of the present invention may include an article of manufacture on a machine accessible or machine readable medium having instructions. The instructions on the machine accessible or machine readable medium may be used to program a computer system or other electronic device. The machine-readable medium may include, but is not limited to, floppy diskettes, optical disks, CD-ROMs, and magneto-optical disks or other type of media/machine-readable medium suitable for storing or transmitting electronic instructions. The techniques described herein are not limited to any particular software configuration. They may find applicability in any computing or processing environment. The terms “machine accessible medium” or “machine readable medium” used herein shall include any medium that is capable of storing, encoding, or transmitting a sequence of instructions for execution by the machine and that cause the machine to perform any one of the methods described herein. Furthermore, it is common in the art to speak of software, in one form or another (e.g., program, procedure, process, application, module, unit, logic, and so on) as taking an action or causing a result. Such expressions are merely a shorthand way of stating that the execution of the software by a processing system causes the processor to perform an action to produce a result. In the foregoing description, the invention is described with reference to specific example embodiments thereof.

The specification and drawings are to be regarded in an illustrative rather than in a restrictive sense. It will, however, be evident that various modifications and changes may be made thereto, in a computer program product or software, hardware or any combination thereof, without departing from the broader spirit and scope of the present invention.

1. An apparatus to facilitate communications between first and second separate communications networks coupled together by at least one traffic carrying link, the apparatus comprising:
a control element that can be coupled to one of the networks,
the element generating at least one message from the one network to be transmitted to a control element coupled to the other network,
the control element includes in the message address information for the traffic carrying link; and
circuitry for translating a first address representation to an address associated with the control element coupled to the other network.

2. An apparatus as in claim 1 where the control element includes a programmable processor and executable software to modify at least part of the message in accordance with a criterion associated with the other network.

3. An apparatus as in claim 2 where the modified message is transmitted to the other network.

4. An apparatus as in claim 3 which includes additional circuitry, coupled to the control element that communicates, at least intermittently, via a computer network with the other network.

5. An apparatus as in claim 4 where the additional circuitry establishes communications with an Internet Service Provider.

6. An apparatus as in claim 2 where the executable software modifies an address portion of the message and forwards the modified message to a second control element associated with the other network.

7. An apparatus as in claim 6 which includes executable software to communicate with the one network by a different network.

8. An apparatus as in claim 7 which includes further software to communicate with the second control element by the different network.

9. An apparatus as in claim 8 where the different network comprises a multiple computer network.

10. An apparatus in claim 8 which includes software to receive a message, via the different network, from the second control element and to modify that message prior to forwarding same to the one network.

11. An apparatus as in claim 10 where an address indicating portion of the message is modified to specify the one network.

12. A method comprising:
determining a message to be sent from one network to a second, different network;
forming the message which includes at least one of signaling information, or, at least one command, and a selected address indicative of the second network;
forwarding the message to a transmitting port;
processing the message, at the transmitting port, to establish a receiving port address at the second network in response to at least the selected network address; and
transmitting the message to the receiving port of the second network.

13. A method as in claim 12 where processing includes altering the message, in accordance with a predetermined criterion associated with the second network, prior to transmitting it.

14. A method as in claim 12 where processing includes translating a first address representation to an address associated with the receiving port of the second network.

15. A method as in claim 12 which includes loading the transmitting port of the first network with address information associated with the second network.

16. A method as in claim 14 where the second network translates an address indicative of the first network to an address of a receiving port thereof.

17. A method as in claim 16 which includes modifying contents of a message at the second network prior to transmitting same to the first network.

18. A method as in claim 17 where translating the address indicative of the first network includes using a pre-established address table.

19. A method as in claim 14 where transmitting includes accessing a third, different network and establishing thereby a different communications path between the one and the second networks.

20. A system comprising:
first and second substantial identical network communication elements each of which includes,
control circuits with an input port that can be coupled to a network,
the circuits can receive at least one message from the network to be transmitted to another network,
the control circuits include address information for the another network, and
circuitry for translating a first address representation received at the input port to an address associated with the another network, and, an input/output port for coupling to a different, computer network.
